(19) United States
(12) Patent Application Publication
(10) Pub. No.: US 2011/0010024 A1
(43) Pub. Date: Jan. 13, 2011

(54) SYSTEM AND METHOD FOR ACCOMPANYING A USER WITH AN AUTOMATED VEHICLE

(76) Inventor: Curt Salisbury, Albuquerque, NM (US)

Correspondence Address: SCHOX PLC, 500 3rd Street, Suite 515, San Francisco, CA, 94107, US

(21) Appl. No.: 12/827,603

(22) Filed: Jun. 30, 2010

Related U.S. Application Data
(60) Provisional application No. 61/222,159, filed on Jul. 1, 2009.

(51) Int. Cl. G06F 19/00

(52) U.S. Cl. 701/2

(57) ABSTRACT

A system and method for accompanying a pedestrian user with an automated, remote vehicle that includes a vehicle control system including a propulsion subsystem that promotes motion of the vehicle and a steering subsystem that controls the direction of motion of the vehicle, a joint goniometer input device wearable by the user that measures an anatomical motion of the user, a communication system that communicates the input of the joint goniometer to the steering subsystem, and a pacing system that outputs a propulsion input that is dependent on the user.

### CROSS-REFERENCE TO RELATED APPLICATIONS

This application claims the benefit of U.S. Provisional Application No. 61/222,159, filed 1 Jul. 2009, titled “ACCOMPANYING CARGO CARRIER”, which is incorporated in its entirety by this reference.

### TECHNICAL FIELD

This invention relates generally to the cargo carrier field, and more specifically to a new and useful accompanying cargo carrier in the cargo carrier field.

### BACKGROUND

There are many situations when a person must push or pull a load as they move. Such situations include pushing a baby stroller, a mail carrier, luggage, and many more applications. Pushing or pulling a cart requires extra exertion, causes a reduction in dexterity, and increases cognitive load for the user. For people that like to run while pushing their children in a stroller, the problem becomes a health issue as well. Many people that run with baby strollers suffer back injuries from poor running form that is a result of manually moving the stroller. Thus, there is a need in the cargo carrier field to create a new and useful accompanying cargo carrier. This invention provides such a new and useful cargo carrier.

### BRIEF DESCRIPTION OF THE FIGURES

FIG. 1 is a schematic representation of a system of a preferred embodiment of the invention;

FIG. 2 is a detailed view of a preferred embodiment of a joint goniometric input device of the preferred embodiment; and

FIG. 3 is a schematic representation of a method of a preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

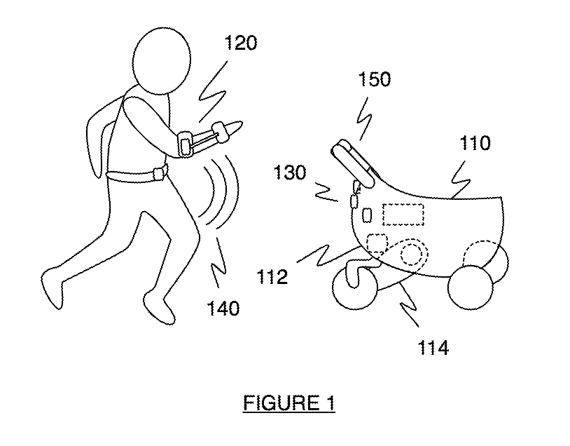

As shown in FIG. 1, the system of the preferred embodiment of an accompanying cargo carrier includes an autonomous vehicle 110 with steering and propulsion subsystems 112 and 114, a joint goniometric input device 120, a pacing system 130, and a communication system 140 for transfer of information between a user and vehicle 110. The system functions to drive a user-accompanying vehicle no using body motion based controls. The system preferably steers and propels the vehicle no with no or little human manipulation of, or contact with, the vehicle no other than through sensed input commands. The system preferably operates in a hands free mode (substantially autonomous except through motion based controls), but may additionally include a manual mode (substantially through normal vehicle modes of operation e.g., pushing, pulling by physical contact). The user is preferably a pedestrian user, someone who is moving by foot, walking, running, or otherwise transporting himself or herself independently from the vehicle, and the vehicle is preferably remotely located. Though, the vehicle is preferably substantially near enough to the user for transitioning to manual control (e.g., arms length or within 10 feet). The system is preferably designed for runners wishing to have an accompanying baby stroller. The system may alternatively be used for any suitable application such as one where a cargo is transported by a wheeled vehicle. As the safety and protection of the cargo (e.g., a user's baby) may be extremely high, numerous safety precautions and learning algorithms may be incorporated to prevent the automated vehicle from deviating from an accompanying path.

The vehicle of the preferred embodiment functions as the controlled device in the system. The vehicle preferably transports a living and/or an inanimate load. The vehicle in one preferred embodiment is designed to carry at least one human infant and/or child. The vehicle may take the form of a traditional baby stroller but may alternatively have altered designed that is more advantageous for hands free control, such as a lower and more centrally located center of gravity and safety structures (such as a roll bar). Alternatively, the vehicle 110 may take the form of any suitable transportation device such as an assisted wheelchair, an animal carrier, a dolly, a mail carrier, luggage, wheelbarrow, wagon, shopping cart, a bike trailer, waste storage container, library storage container, military personal cargo carrier, a sled (preferably similar to an unmanned snow-mobile), un-manned boat, or any suitable movable device. In one preferred embodiment, the vehicle no includes one steerable backwheel and two front wheels, where at least one of the wheels is connected to a motor. The vehicle no preferably includes a steering subsystem 112 that functions to electronically control the direction of the vehicle 110. The steering subsystem 112 preferably controls the direction of at least one wheel through motor or pneumatic control, but the steering subsystem 112 may alternatively control any suitable device to alter the direction of the vehicle such as by changing the speed ratio between two wheels. The vehicle additionally may include a propulsion subsystem 114, which functions to engender transporting motion of the vehicle. The propulsion subsystem 114 is preferably a motor drive system that drives at least one wheel of the vehicle, but may alternatively be any suitable mode of propulsion.

The joint goniometric input device 120 of the preferred embodiment functions to control the motion of the vehicle based on measured body position and/or movement. The joint goniometric input device 120 further functions to allow control of a device through non-obtrusive, natural actions. The joint goniometric input device 120 preferably controls steering of the vehicle no, but may alternatively or additionally control the propulsion of the vehicle no or any suitable controllable aspect of the vehicle 110. The joint goniometric input device 120 is preferably a device worn by the user, preferably near or along a joint (or body part). The joint goniometric input device 120 preferably uses variations in the movement of the body during a physical activity such as walking, running, swimming or any suitable activity. The variations and interaction with the joint goniometric input may be planned by the user or the interaction may be natural tendencies during an activity such as the change in a stride when a user turns. In one preferred embodiment, the joint goniometric input device 120 measures the pronation/supination (i.e., rotation) of the forearm. The angle of rotation of the forearm preferably corresponds to the turning of the vehicle 110. For example, when worn on the right arm, pronation of the arm from a typical running arm position preferably results in a left turn for the vehicle no, and supination of the forearm preferably results in right turn for the vehicle 110. The joint goniometric input device 120 may alternatively measure the abduction/adduction of the shoulder, the left and right leaning at the waist, the flexion/extension of the elbows, and/or any suitable body motion. The joint goniometric input device 120 may additionally include a processor that functions to process sensor information to recognize body motion. For example, the processor may measure the periodic motion of a runner swinging an arm and detect a turn, tiredness, or any suitable characteristic based on variations in the periodic motion.

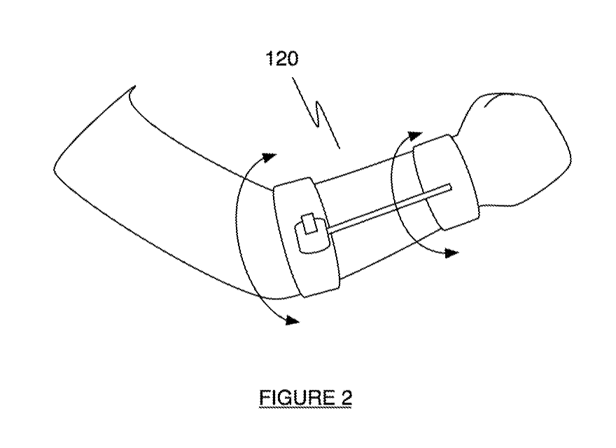

The joint goniometric input device 120 is preferably an electronic goniometer (an electronic device to measure angle of a joint). As shown in FIG. 2, in the preferred embodiment, the joint goniometric input device 120 measures the pronation/supination of the forearm by measuring the relative rotation between the proximal portion of the forearm (near the elbow) and the distal portion of the forearm (near the wrist). A distal band is preferably worn around distal portion of the forearm and a proximal band is worn around the proximal portion of the forearm. A length of wire or alternatively a rod is preferably connected to one of the two bands with the other end of the wire fitting into a fixture. The fixture is preferably attached to the band without the wire connection and preferably allows for motion of the wire, and more preferably allows for either rotation or linear motion of the wire The wire preferably resists a twisting motion along the central axis and is resistant to tensile forces (does not stretch), but the wire may flexible in other axis. A sensor or encoder is preferably integrated into the fixture and preferably senses the rotation of the wire. Alternatively, the sensor may be designed to detect linear motion of the wire. Pronation or supination of the forearm will cause one portion of the wire to rotate. This rotation will translate to rotation of the wire within the fixture (which has a different amount of rotation during the pronation). The sensor preferably electronically measures the relative rotation of the distal band and the proximal band. The electronic signal is preferably communicated to the vehicle 110. This concept of a wire-based goniometer may be applied to determine any suitable joint or body motion. Alternatively, any suitable goniometer device may be used.

The pacing system 130 of the preferred embodiment functions to detect and regulate the speeds and proximity of the vehicle 110 and the user. The pacing system 130 preferably relies on a user dependent or influenced input, which may be consciously activated or be sensed properties of the user position/motion. The pacing system 130 preferably maintains a substantially constant distance between the user and the vehicle no, and thus the pacing system 130 preferably adjusts the speed of the vehicle no to substantially match the speed of the user. Preferably, the pacing system 130 senses the relative distance between the vehicle no and the user, and regulates the propulsion subsystem 114 of the vehicle 110 to maintain a distance within a maximum and/or minimum distance. The pacing system 130 preferably has an IR emitter or reflector that is worn by the user, such as a band worn around the waist. The vehicle no preferably includes at least one IR receiver to detect the signal strength from the IR emitter. The vehicle no more preferably includes three IR receivers that function to triangulate the position of the IR emitter for better approximation of the distance between the vehicle no and the user, and can preferably determine a two-dimensional or three-dimensional approximation of the relative position of the user of the vehicle 110. The position of the user behind or in front of the vehicle no (e.g., to the right or to the left) may additionally be detected and used as an input for the steering subsystem (for either subtle or major changes in trajectory). The pacing system 130 may alternatively use ultrasound devices, Radio Frequency (RF) range finders, a vision system, a mechanical sensor for a linkage attached to the user or any suitable sensor for range detection. In one embodiment, an extendable/retractable cord is preferably connected to the user and the vehicle 110. As the cord is extended or retracted the length of cord is preferably sensed to determine the speed for the vehicle 110. The cord may additionally be used as a safety kill switch and/or a communication channel between the user and vehicle 110. Alternatively, the pacing system 130 may use other metrics for regulation of the propulsion subsystem 114 of the vehicle no such as sensing the speed of the runner, absolute geo-based location, user physical exertion, retroreflection, chemical footstep following, or any suitable metric to determine how to regulate the propulsion subsystem 114. The pacing system 130 in one variation may use the joint goniometric input as the sensor or use an additional sensor similar to the joint goniometric input for measuring body motion. In yet another alternative, the pacing system 130 may use direct user control of speed via a throttle, analog button, dial, or any suitable input device that the user may use to directly change the speed of the vehicle 110. The pacing system 130 may additionally be used as an input for the steering subsystem 112.

The communication system 140 of the preferred embodiment functions to transfer electronic information between the user and the vehicle 110. The communication system 140 preferably communicates information from the joint goniometric input to the vehicle no and may additionally transfer information from a sensor (or input) of the pacing system 130. The communication system 140 preferably is a wireless system using any suitable wireless communication system 140 such as RF, Bluetooth, or any suitable protocol or system. In one variation, the signal from the joint goniometric input device 120 is preferably encoded within the range finding signal of the pacing system 130, such as encoding the joint goniometric input signal in the IR light of the pacing system 130. The communication system 140 may alternatively be a wired connection that provides electronic communication. The wire is preferably a flexible cord that extends from the user to the vehicle 110. The physical wire is preferably able to automatically disconnect when the cord is fully extended or when a force above a safety threshold is exerted on the wire.

The preferred embodiment preferably includes a processor that functions to control the electronics of the system. The main processor is preferably located on the vehicle 110, but may alternatively be part of the system worn by the user or include multiple processors. The processor preferably controls the steering subsystem 112, the propulsion subsystem 114, the communication system 140, pacing system 130, the joint goniometric input device 120, and/or any suitable aspect of the system.

The processor may additionally be used to implement a path learning process. The path learning process functions to learn the paths taken by the user. For example, a path run by a user during a daily run will preferably be learned over time by the system and the learned path is preferably used to improve control of the vehicle 110. The path learning may be used to improve safety of the device (e.g., prevent deviations from the learned path). The processor preferably uses the inputs from the joint goniometric input device 120 and the pacing system 130 to form an average path input. Specifically, the processor uses turning information from the joint goniometric input device 120, the pacing system 130 for velocity information, and additionally distance traveled by the vehicle no (which may be gather from any suitable odometer sensor). The user preferably activates the path learning substantially near the beginning of any path before starting a session. The inputs from different sessions are preferably similar for a path (e.g., a user will indicate a similar degree of turn after running a set distance from a previous turn), and by monitoring the inputs and/or outputs, an average path may be learned. The path learning may additionally be used to implement a training program where the vehicle 110 sets the pace and may encourage the user to improve performance. The training program may provide information for lap times running times, average speed, maximum speed, speed versus time information, or any suitable data. The recording of path history is preferably transferable to a personal computer for any suitable analysis. The speed of the vehicle 110 may additionally be increased above the average speed of a user to encourage the user to run faster or the speed may be set to achieve any suitable goal.

The preferred embodiment may additionally include a safety system 150 that functions to activate safety measures that prevent damage to the vehicle 110, the user, any cargo/passengers, and/or other objects. The safety system 150 preferably includes a kill switch that is a flexible cord connecting the user and the vehicle 110. The cord preferably disengages when the cord is fully extended or when a force above a safety threshold is exerted on the cord. The kill switch may alternatively be a wireless signal that when the user is out of range (such as greater than 10 feet away) the vehicle 110 slows or stops. The vehicle 110 may additionally or alternatively include handlebars which when gripped preferably changes the operation mode of the vehicle 110. The vehicle 110 preferably switches from a hands free mode to a manual mode where the steering subsystem 112 and propulsion subsystem 114 are preferably disengaged. The vehicle 110 may alternatively brake or take any suitable action. The vehicle 110 may additionally include cargo safety devices such as a roll bar, airbags, safety harness, or any suitable injury preventative devices.

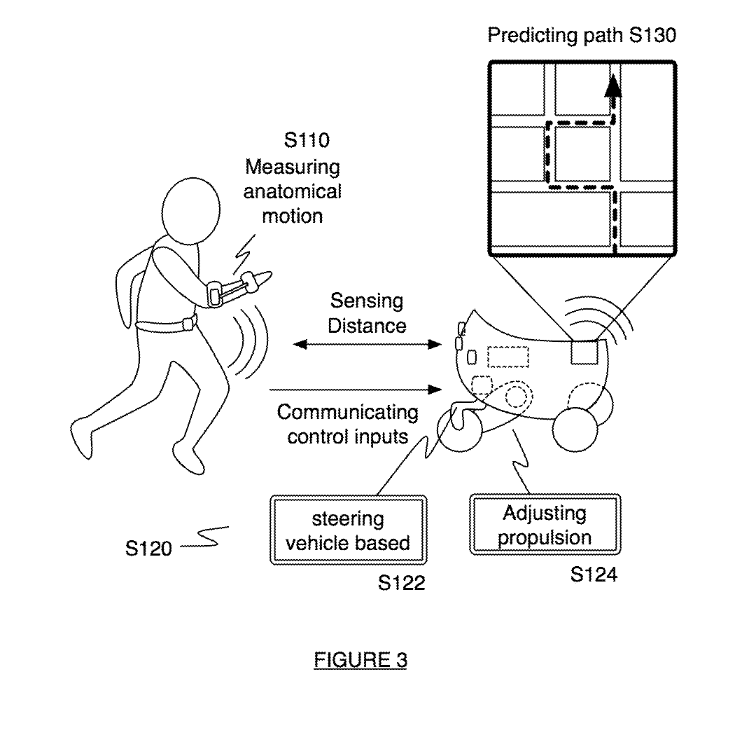

As shown in FIG. 3, a method for accompanying a user with an automated vehicle of a preferred embodiment includes measuring an anatomical motion of a user S110; and controlling the vehicle from control inputs S120 including the sub-steps of steering the vehicle based on the measured anatomical motion S122; and adjusting the propulsion of the vehicle through a user influenced input S124. The method functions to drive a user-accompanying vehicle using body motion based controls. Additionally, the method functions to enable a vehicle to accompany a user such as by trailing behind the user or remaining in front of the user. In particular, the method has application to controlling the driving of a baby stroller with unobtrusive controls based on input from a user walking or running near the stroller. In one application, the method is used such that a runner can run naturally and have the baby stroller drive ahead of the runner. The method may alternatively be used for any suitable application such as an automated vehicular cargo transport. The method is preferably implemented by a system substantially similar to the one described above, but any suitable system may be used.

Step S110, which includes measuring an anatomical motion of a user, functions to detect position or motion of the body of the user. The anatomical motion is preferably used to control the steering of the vehicle. The anatomical motion may alternatively or additionally be used for controlling the speed of the vehicle or any suitable control of the vehicle. A joint goniometric input device substantially similar to the one described above is preferably used for measuring the anatomical motion of the user. Relying on anatomical motion of a user preferably frees the user to perform desired tasks (e.g., running). The anatomical motion is preferably passively sensed and does not require a user to actively engage a device (e.g., pressing a button or manipulating a switch). The anatomical motion may be consciously made such as a slight twisting of the forearm in a desired direction but may alternatively be a natural tendency indicative of the trajectory of the user such as leaning to the right when turning right. Preferably, a relative rotation between a distal portion and proximal portion of a forearm of the user is preferably measured. The direction of rotation preferably determines the steering direction. If the forearm rotates towards a pronational position of the forearm, the steering input of the vehicle is preferably in a first direction, and if the forearm rotates towards a supinational position of the forearm, the steering input of the vehicle is preferably in a second direction. For example, if the right forearm is rotated to the right such that the right palm is up, the vehicle preferably steers towards the right. If the right forearm is rotated to the left such that the right palm is down, the vehicle preferably steers towards the left. The degree of rotation or motion preferably impacts the magnitude of the input (e.g., how hard to steer in one direction).

Step S120, which includes controlling the vehicle from control inputs, functions to move the vehicle in a desired manner. The user is preferably remotely located in relation to the vehicle or in other words has no personal connection to the vehicle from which the user may physically manipulate the vehicle. However, the user is preferably substantially near the vehicle, preferably within arms reach of the vehicle (to preferably transition to manual control if need be). The vehicle may additionally include a manual mode where the vehicle is manipulated through other means. The manual mode may be engaged at any suitable time. In one example, a baby stroller preferably has a handle that is designed for physically directing the vehicle. The handle may include grip sensors that when the user grips the handlebars, the automated controls are turned off and the manual mode is turned on. Step S120 preferably includes the sub-steps of steering the vehicle based on the measured anatomical motion S122; and adjusting the propulsion of the vehicle through a user influenced input S124.

Step S122, which includes steering the vehicle based on the measured anatomical motion, functions to direct the vehicle in an appropriate direction. More preferably the steering is performed to track/mimic the direction of motion of the user. For example, if a user turns right the vehicle preferably turns right to the same degree. A control system is preferably implemented to filter and optimize the steering of the vehicle. The measured anatomical motion is preferably the relative rotation angle of the distal portion and proximal portion of the forearm, but any suitable anatomical motion may alternatively be used such the leaning of the hips or head.

Step S124, which includes adjusting the propulsion of the vehicle through a user influenced input, functions to adjust the speed of the vehicle according to the user. The propulsion of the vehicle is preferably adjusted by a propulsion subsystem substantially similar to the one described for the system above. The speed of the vehicle is preferably adjusted to match that of the user such that the user stays within a set distance range from the vehicle. In an example where the vehicle is in front of the user mirroring the movement of the user, the vehicle preferably reduces speed if the relative position of the user exceeds a first distance, and increases speed if the relative position of the user is below a second distance. In an example where the vehicle follows behind a user, the vehicle preferably reduces speed if the relative position of the user is below a first distance, and increases speed if the relative position of the user exceeds a second distance. The adjustment of propulsion is preferably based on a multi-order control system dependent on user position, speed, acceleration, etc.

Additionally, the method may include predicting a path of the vehicle S130, which functions to use historical information for modifying the control inputs. Prediction of a path preferably additionally includes learning a path which functions to record regular paths the user takes with the accompanying vehicle. This is particularly useful for the application of a baby stroller designed for a parent that is a runner, who would typically repeat paths or running courses with the baby stroller. Learning a path preferably includes collecting GPS data or any suitable positioning data and storing the GPS data along with control inputs A correlation can preferably be calculated based on location and the control inputs such as the anatomical motion and/or user-influenced input (e.g., how fast the user moves in particular locations). Based on this historical data, control inputs may be augmented with predicted control inputs. For example, there may be a corner on a user's daily run where the runner always turns right. The predicted inputs would preferably be anatomical motions that indicate a right turn, and any current anatomical motion input would preferably be biased for a right turn. Predicting a path of the vehicle may alternatively be used for learning the correct interpretations of the user input or any suitable application.

As a person skilled in the art will recognize from the previous detailed description and from the figures and claims, modifications and changes can be made to the preferred embodiments of the invention without departing from the scope of this invention defined in the following claims.

I claim:

1. A system for accompanying a pedestrian user with an automated, remote vehicle comprising:
a vehicle control system for automated motion of the remotely located vehicle determined by vehicle control inputs including:
a propulsion subsystem that promotes motion of the vehicle;
a steering subsystem that controls the direction of motion of the vehicle;
a joint goniometer input device wearable by the user;
a communication system that communicates the input of the joint goniometer to the steering subsystem; and
a pacing system that outputs a propulsion input that is dependent on the user.

2. The system of claim 1, wherein the goniometer input device includes proximal portion and a distal portion and a sensor to measure the relative rotation between the proximal portion and the distal portion.

3. The system of claim 1, wherein the pacing system dependent on the user includes a distance sensor that measures the relative distance from the user to the vehicle.

4. The system of claim 3, wherein the communication system is a wireless communicator.

5. The system of claim 3, wherein the distance sensor includes a plurality of distance sensors that determine at least a two-dimensional relative position of the user near the vehicle.

6. The system of claim 3, wherein the pacing system includes an extendable cord connectable between the vehicle and the user, wherein the distance sensor detects the length of the cord extended.

7. The system of claim 6, wherein the extendable cord has a set length above which the propulsion subsystem and steering subsystem deactivate control of the vehicle.

8. The system of claim 7, wherein the extendable cord includes an electrical communication channel integrated with the communication system.

9. A system of claim 1, further comprising a processor with a path learning process that augments the control of the vehicle control system.

10. A system of claim 9, further comprising a global positioning system (GPS), wherein the path-learning process stores data from the GPS and inputs of the vehicle control; and the path-learning process outputs modified vehicle control inputs.

11. The system of claim 1, further comprising a manual control connected to the vehicle that detects when engaged and deactivates the vehicle control system.

12. The system of claim 1, further comprising:
a manual control connected to the vehicle that detect when engaged and deactivates the vehicle control system;
wherein the goniometer input device includes a proximal portion and a distal portion and a sensor to measure the relative rotation between the proximal portion and the distal portion;
wherein the pacing system dependent on the user includes a distance sensor that measures the relative distance from the user to the vehicle.

13. A method for accompanying a pedestrian user with an automated, remote vehicle comprising:
measuring an anatomical motion of the user;
controlling the vehicle from control inputs while the user is remotely located including:
steering the vehicle based on the measured anatomical motion; and
adjusting the propulsion of the vehicle through a user influenced input.

14. The method of claim 13, adjusting the propulsion of the vehicle through a user-influenced input includes receiving a user input from a throttle; wherein the user-influenced input is the user input from the throttle.

15. The method of claim 13, adjusting the propulsion of the vehicle through a user-influenced input includes measuring a relative position between the user and the vehicle; wherein the user-influenced input is the measured relative position.

16. The method of claim 15, wherein adjusting the propulsion of the vehicle through a user influenced input includes reducing the speed of the vehicle if the relative position of the user exceeds a first distance; and increasing the speed of the vehicle if the relative position of the user is below a second distance.

17. The method of claim 15, wherein measuring an anatomical motion of a user includes measuring a relative rotation between a distal portion of a forearm of the user and a proximal portion of a forearm of the user.

18. The method of claim 17, wherein steering the vehicle based on the measured anatomical motion further includes steering the vehicle in a first direction when measuring a forearm rotation towards a pronation of the forearm; and steering the vehicle in a second direction when measuring a forearm rotation towards a supination of the forearm.

19. The method of claim 13, further comprising detecting contact on a manual control apparatus of the vehicle; and disengaging steering and propulsion upon sensing of contact.

20. The method of claim 13, further comprising collecting global positioning system (GPS) data; storing a historical record of GPS and control inputs; predicting control inputs for steering and propulsion of the vehicle based on the historical record and a current GPS coordinate; and augmenting the measured anatomical motion and user-influenced input with the predicted control inputs.
